(19) United States
(12) Patent Application Publication
(10) Pub. No.: US 2012/0000657 A1
(43) Pub. Date: Jan. 5, 2012

(54) Treatment fluid for wells drilled in oil mud, in the form of a delayed effect water-in-oil emulsion

(76) Inventors: Christine Dalmazzone, Viroflay (FR); Annie Audibert-Hayet, Croissy-Sur-Seine (FR)

(21) Appl. No.: 12/528,182

(22) PCT Filed: Feb. 19, 2008
(86) PCT No.: PCT/FR08/00222

§ 371 Date: Nov. 9, 2010

(30) Foreign Application Priority Data
Feb. 21, 2007 (FR) 0701251

(51) Int. Cl. E21B 37/06; C09K 8/52

(52) U.S. Cl. 166/304; 507/203; 507/219; 507/261; 507/262; 507/248; 507/246; 507/240; 507/244; 507/267

(57) ABSTRACT

The invention concerns a treatment fluid for wells drilled in oil mud in the form of an emulsion of water in oil comprising:
a continuous organic phase comprising at least one emulsion-breaking organo-soluble additive;
a dispersed aqueous phase including at least one solid-dissolving agent for the controlled destabilization of the processing fluid;
at least one emulsifying agent;
at least one weight-increasing agent;
   the proportion and the nature of the hydrosoluble additive being chosen so as to obtain a delay effect for the destabilization of the emulsion so as to be compatible with the tank fluids.

The invention also concerns a method of processing wells bored with oil-based muds, using said processing fluid.

### TECHNICAL SECTION

The invention concerns the processing of wells, in particular wells bored by oil-based fluids. It concerns more particularly a non damaging formulation, intended for cleaning, if possible in a single step, water injection wells, in the form of a delayed-effect water-in-oil emulsion.

### PRIOR ART

A rocky formation, for example a petroleum deposit, is said to be damaged when a well drilled in this formation turns out to be less productive than what was predicted by the analyses of the production tests carried out in this well. The mechanisms of damage of the formation depend on the type of reactions produced between the fluid(s) used to drill the well, the fluids contained in the formation and the nature of the rock, in the conditions of work (pressure and temperature of the formation). The alteration of the producing formation close to the well is due to the injurious interactions between the formation fluids and the foreign fluids introduced. If the well fluids turn out to be responsible for the damage, a chemical treatment is then necessary in order to restore the characteristics of the reservoir. It must make it possible to destroy the external and/or internal cake and to clean the damaged zones at the periphery of the well. This treatment may or may not be associated with an acid-type treatment of the matrix.

Cleaning of the Boreholes

At the time of drilling with an oil-based mud, the pressure in the well (P₁) being generally superior to that of the formation (P₂), the solid particles of the mud form a deposit, called “cake” on the walls of the well which makes it possible to maintain the stability of the walls and to limit the filtration. The mud circulates in a closed circuit and its properties, notably control of the filtrate, must be modified not at all or very little. The deposited cake thus contains filtrate-reducing additives whose principal function is to limit the quantities of fluid filtering into the formation. This cake, both external and internal, will have as a consequence a reduction of the permeability of the rock and thus of the productivity of the well. That is, the deposit fluid will circulate with more difficulty in the rock in order to flow into the well. The process of cleaning is thus necessary in order to obtain the best production of petroleum possible.

A chemical treatment is often used in order to destroy the external cake and clean the damaged zone of the borehole, so that the formation regains its properties of liquid flow (water, petroleum). The treatment consists of destabilizing, or “breaking” the emulsion of the filtration cake in order to favor the coalescence of the droplets of water. Systems based on an aqueous solution, generally acid for the cakes with a carbonate base, or mutual solvents are known, as well as emulsion breakers in organic phase for the cakes formed from oil mud. The cake is then broken down by using the emulsion breaker in organic phase, and during the return to production after the treatment.

Different methods have been considered in the prior art for the treatment of wells on site:

U.S. Pat. No. 590,774 describes, as an example, a three-step procedure comprising the successive use of three processing fluids, the first and the second fluid being constituted of water, of an acid to dissolve the cake, of a mutual solvent and an emulsion penetration agent. The third step uses a processing fluid in aqueous phase comprising an acid to continue the dissolution of the filtration cake and a wetting agent.

Another method (WO2004/027213) proposes a slow salting out of an acid product after a very dense emulsion breaker used in the form of a “gravel pack,” the acid product making it possible to dissolve or to break the composites of the filtration cake in a producing formation.

A delaying effect can be obtained by microencapsulation of a peroxided source which is activated by the modifications of pH in the well (WO 03/054109).

The water injection wells are used when the pressure in the reservoir zone becomes too weak and the recuperation of the petroleum becomes difficult. A well is then drilled up to the producing zone, in order to then inject water under pressure. This procedure makes it possible to raise the pressure in the reservoir and thus favor better recuperation.

In the particular case of these wells, the circulation of the water is done in the same direction as the filtration of the mud (one injects the well water toward the formation) and not in the inverse direction, like the production of petroleum. There will thus not be any “Back-Flow,” or any loosening of the cake naturally by the fluids of the well during the return to petroleum production. The cleaning of these wells is more difficult. In fact, the water, injected in the same direction as the drilling fluid filtrate, that is from the well toward the formation, runs the risk of bringing along particles of cake into the formation, and even of provoking the formation of an emulsion with the petroleum, and of damaging the rock even more.

In these conditions, the use of the cleaning product consisting of breaking the emulsion of the filtration cake in order to favor the coalescence of the droplets of water and to make it possible to break down the cake during the return to production (“Back-Flow”) is ineffective. In the case of water injection wells, given that there is no return to production, but direct injection of water, it is not sufficient to break down the cake by coalescence of the droplets of water, but it is also necessary to disperse or dissolve the solids of the cake.

As well, industrially, the purpose of this invention is to perfect an emulsion which makes it possible to carry out on site and in a single step, in an efficient manner:
the breaking of the emulsion in the cake
the dissolution of solid particles of the cake (for example: calcium carbonate or barium sulfate)
   Moreover, the emulsion must have a density sufficient to avoid the influxing liquids, advantageously of around 1.2 and it must be stable for at least the duration of the pumping (in general of the order of several hours), but it must destabilize (clean separation of the aqueous and organic phases) preferably before 24 hours so that the products present in the two phases can act on the formation.

An optimal formulation of the water-in-oil emulsion has been perfected in an advantageous manner in a procedure of treatment of the water injection wells in a single step, which makes possible, by its delaying effect (controlled kinetics of breaking of the water-in-oil emulsion), the breaking down of the emulsion within the cake, because of the continuous organic phase which contains the emulsion-breaking organo-soluble additive, followed by the dissolution of the solids by the aqueous phase liberated during the breaking of the emulsion.

### Purpose of the Invention

The invention concerns a processing formulation for oil-based mud bored wells, preferably injection wells, in the form of a delayed effect oil-in-water emulsion comprising:
1. a dispersed aqueous phase including at least one solid-dissolving agent and an additive in aqueous phase making it possible to control the kinetics of breaking of the emulsion,
2. a continuous organic phase comprising at least an emulsion-breaking additive (“breaker”) in oil phase,
3. at least one emulsifier,
4. and at least one weight-increasing agent (in the form of soluble salts).

The invention also concerns a method of treatment of oil-based mud bored wells, notably the injection wells, in particular of water, in a single step, using said formulation.

### DESCRIPTION OF THE INVENTION

### Summary

The invention concerns a processing fluid for oil-based mud bored wells in the form of a water-in-oil emulsion comprising:
a) a continuous organic phase comprising at least one organo-soluble emulsion-breaking additive;
b) a dispersed aqueous phase comprising at least one solid-dissolving agent and at least one hydrosoluble additive making possible the controlled breaking down of the processing fluid;
c) at least one emulsifying agent;
d) at least one weight-increasing agent in the form of soluble salts, the proportion and the nature of the hydrosoluble additive being chosen so as to obtain a delayed effect for the breaking down.

Advantageously, the processing fluid is compatible with the tank fluids.

Preferably, the fluid comprises from 20 to 80% in volume of continuous organic phase. Advantageously, the emulsifier is a nonionic surfactant.

The treatment fluid preferably comprises from 0.05% to 3% weight of emulsifier with respect to the continuous organic phase, in a very preferred manner of 0.1 to 1% of the weight of the emulsifier with respect to the continuous organic phase, and in an even more preferred manner of 0.2 to 0.8% of the weight of the emulsifier with respect to the continuous organic phase.

Advantageously, the organo-soluble emulsion breaker is an organic formulation comprising at least one constituent chosen from among the nonionic or cationic surfactants of the type copolymers of ethylene oxide and propylene oxide, the derivatives of alcohols or of phenols with alkoxylate or polyalkoxylate chains, polyalkylene glycols, polyamines, alkoxylated or polyalkoxylated derivatives of amines, quaternary ammonium salts, quaternized alkanolamine esters, and the silicone derivatives, the nonionic amphiphile compositions obtained by reaction of at least one polymerized vegetable oil, on at least one amino alcohol, and the alkylic esters of fatty acids derived from natural, vegetable, or animal oils, as well as any other fatty acid derivative, in particular the polymerized unsaturated monocarboxylic fatty acids.

The agent of dissolution of the solids is preferentially chosen from among the weak or strong acids, the mixtures of strong acids and chelating agents, and the specific agents of dissolution of barytine, alone or in a mixture.

The hydrosoluble additive is preferably a weakly hydrolysable ester of fatty acid.

The weight-increasing agent is advantageously chosen from among the anionic salts of the chloride, bromide, and formate type, the cation being chosen from among calcium, sodium, potassium, and cesium.

Preferably, the weight-increasing agent is potassium formate or cesium formate.

The invention also concerns a method of processing of wells drilled in oil-based muds in a single processing step c) in which:
we prepare a processing fluid in the form of a water-in-oil emulsion comprising:
   a continuous organic phase comprising at least one emulsion-breaking organo-soluble additive;
   a dispersed aqueous phase comprising at least one solid-dissolving agent and at least one hydrosoluble additive allowing for a delayed effect of the breakdown of the processing fluid;
   at least one emulsifying agent;
   at least one weight-increasing agent in the form of soluble salts.
we inject the said emulsion in the well while controlling the kinetics of breakdown of the processing fluid by means of the hydrosoluble additive so as to ensure the breaking of the water-in-oil emulsion in place;
we treat the well by breakdown of the filtration cake on the wall by means of the organo-soluble additive and by dissolution of the cake solids by means of the solid-dissolving agent.

Advantageously we verify the compatibility of the processing fluid with the tank fluids. Preferably, the well is an injector well, in a very preferential manner a water injection well. Advantageously the organo-soluble additive is an organic formulation comprising at least one constituent chosen from among the nonionic or cationic surfactants of the type: copolymers of ethylene oxide and propylene oxide, the derivatives of alcohols or of phenols with alkoxylated or polyalkoxylated chains, polyalkylene glycols, polyamines, alkoxylated derivatives or polyalkoxylated amines, quaternary ammonium salts, quaternized alkanolamine esters, and silicone derivatives, nonionic amphiphile compositions obtained by the reaction of at least one polymerized vegetable oil, on at least one amino alcohol, and the alkylic esters of fatty acids derived from natural, vegetable, or animal oils, as well as any other derivative of fatty acids, in particular the polymerized unsaturated monocarboxylic fatty acids.

Advantageously the solid-dissolving agent is chosen from among the weak or strong acids, the mixtures of strong acids and chelating agents, and the specific barytine dissolving agents, alone or in a mixture.

Preferably, the hydrosoluble additive which allows for the delayed effect is a weakly hydrolysable ester of fatty acid.

### DETAILED DESCRIPTION OF THE INVENTION

The well-processing formulation, preferentially for water injection wells, is presented in the form of a water-in-oil emulsion with delayed effect comprising:
1. a dispersed aqueous phase including at least one solid-dissolving agent and one additive in aqueous phase which makes it possible to control the kinetics of breaking the water-in-oil emulsion,
2. a continuous organic phase comprising at least one emulsion-breaking additive (“breaker”) in oil phase,
3. at least one emulsifier,
4. and at least one weight-increasing agent (in the form of soluble salts).

The water/oil volume relationship in the emulsion is generally comprised between 20/80 and 80/20, preferentially it is of the order of 50/50.

### Continuous Organic Phase

The usable emulsion-breaking additives in organic phase according to the invention are chosen in particular from among the de-emulsioning formulations comprising:

1.—as a de-emulsioning agent, at least one constituent chosen from among the non-ionic or cationic surfactants of the type: copolymers of ethylene oxide and propylene oxide, the derivatives of alcohols or of phenols with alkoxylated or polyalkoxylated chains, polyalkylene glycols, polyamines, alkoxylated derivatives or polyalkoxylated amines, quaternary ammonium salts, quaternized alkanolamine esters, and
the siliconized derivatives, the non-ionic amphiphilic compositions obtained by the reaction of at least one polymerized vegetable oil, on at least one aminoalcohol, and the alkylic esters of fatty acids derived from natural, vegetable, or animal oils, possibly alkoxylated or polyalkoxylated, as well as any other derivative of fatty acids, in particular the polymerized unsaturated monocarboxylic fatty acids;
possibly by means of a wetting agent chosen from among the anionic surfactants;
and possibly at least one solvent;
   the whole being in a mixture in one organic base.

The organic base can be any organic base, preferably an oil, a petroleum fraction: diesel fuel, gasoline, kerosene or esters of natural vegetable or animal oils or even petroleum fractions of low toxicity comprising the olefins or the n- or iso-alkanes.

The formulations and composites cited above are described in the patents EP 1 190 754 A1 and EP 1 208 898 A1. However, any organo-soluble composition known to a person skilled in the art which allows for the breakdown of the emulsion within the cake is appropriate.

Preferably, the organo-soluble emulsion-breaking additive is Radiagreen CLO™ by Oleon.

### Dispersed Aqueous Phase

The solid-dissolving agents are all the products used in aqueous phase known to the person skilled in the art, in particular the strong or weak acids which make it possible to dissolve the carbonates in particular.

Other agents can be used alone or in a mixture with the acids, to dissolve more specifically barytine, in particular the mixtures of strong acids and chelating agents (for example a mixture of fluorhydric acid, of chlorhydric acid and EDTA), or agents specifically directed toward the dissolving of barytine such as HDC Mark II or III sold by Well-Flow International.

In the formulation of processing fluid according to the invention, the aqueous phase also comprises a surfactant additive in aqueous phase which makes it possible by an advantageous manner to control the kinetics of breaking of the emulsion by delayed effect.

The surfactant additive in aqueous phase is advantageously chosen from among the fatty acid esters. Preferably, said fatty acid ester is weakly hydrolysable so as to ensure the maintenance of its initial surfactant properties.

Advantageously, the additive in aqueous phase is a composition such as described in the patent FR 2 811 326, that is a concentrated composition of one or more compounds chosen in the group of partial esters of polyhydric alcohols with fatty acids on C6-C22, the lengths of chains of the acid and alcohol parts being chosen such that the ester thus obtained presents sufficient dispersion in the water, compatibility with said constituents, does not form any emulsion with the tank oil and is adsorbed sufficiently on the porous formation.

Preferably the length of the fatty acid chain is comprised between C6 and C12 and in an even more preferential manner, between C8 and C10.

Preferably, in the partial ester, the molar relationship of the number of free hydroxyl groups to the number of hydroxyl groups esterified by a fatty acid is of at least 1:1, in a very preferred manner at least 2:1, in an even more preferred manner at least 3:1.

Preferably, the composition is an ester of polyglycerol and C8-C10 fatty acid.

A preferred composition of polyglycerol consists of: between 24 and 30% of glycerol, preferably 27%; between 28 and 34% of diglycerol, preferably 31%; between 20 and 26% of triglycerol, preferably 23%, between 9 and 15% of tetraglycerol, preferably 12%; between 4 and 10% of pentaglycerol, preferably 7%.

Radiagreen RA™ from Oleon is a very advantageous choice.

Emulsifier: All the classic surfactant emulsifiers can be used, preferably the non-ionic surfactants. A preferred agent is Radiagreen 7155 by OLEON.

The quantity of emulsifier is generally comprised between 0.05 and 3% by weight with respect to the organic phase, advantageously between 0.1 and 1%, preferably 0.2-0.8%, in a very preferred manner of the order of 0.7% so that the emulsion may be sufficiently stable without being viscous.

Weight-increasing agent: the weight-increasing agent which in particular makes it possible to give the desired density to the formulation is chosen from among the classic soluble weight-increasing agents, in particular the anionic salts of the types: formate, chloride, bromide. The cation is preferably chosen from among calcium, potassium, cesium, sodium. The preferred salts are the formate-based salts, in particular potassium formate or cesium formate.

### EXAMPLES

### Example 1

### Muds and Formulations Used

Two drilling fluids (oil muds) have been selected, each one being weighted by different compounds:

OBM1: mud weighted by carbonates only (density 1.14)
OBM2: mud weighted by a barytine/carbonate mixture (75%/25% by weight) (density 1.14).

The compositions of the muds are given below:

Mud weighted with barytine+carbonate (OBM2):

| | | |
|---|---|---|
| Basic oil | 0.556 | m3 |
| Emulsifier | 34.2 | kg/m3 |
| Calcium hydroxide | 11.4 | kg/m3 |
| Sodium hydroxide | 2.8 | kg/m3 |
| Filtrate-reducing agent | 5.7 | kg/m3 |
| Viscosifying agent | 17.1 | kg/m3 |
| Water | 0.32 | m3 |
| Calcium chloride | 109.4 | kg/m3 |

Mud weighted with carbonates (OBM1):

| | | |
|---|---|---|
| Basic oil | 0.682 | m3 |
| Emulsifier 1 | 11.4 | kg/m3 |
| Emulsifier 2 | 11.4 | kg/m3 |
| Filtrate reducer 1 | 17 | kg/m3 |
| Calcium hydroxide | 17 | kg/m3 |
| Filtrate reducer 2 | 8.6 | kg/m3 |
| Water | 0.231 | m3 |
| CaCl2 at 97% | 79.57 | kg/m3 |
| viscosifier 1 | 8.6 | kg/m3 |
| viscosifier 2 | 11.4 | kg/m3 |

### Formulation of the Emulsions

Bo1=Radiagreen CLO™, Bw1 is an organic acid, Bw2=HDC Mark II,

### EB1=Radiagreen RA™

The emulsions have been prepared on the basis of an organic phase and an aqueous phase.

The organic phase is composed of a mineral oil of weak toxicity (HDF2000) containing the organo-soluble cake breaker (Bo1), and an emulsifier which allows for the formation and the stabilization of the emulsion (Em1).

The aqueous phase is composed of brine to adjust the density of the fluid (potassium formate and possibly cesium formate), plus a carbonate-dissolving agent (organic acid Bw1) and/or a barytine- and carbonate-dissolving agent Bw2. Another hydrosoluble additive (surfactant) is used to control the kinetics of emulsion breaking (EB1). All the additives are available commercially.

The emulsions are made by the addition of the aqueous phase in the organic phase under agitation at 6,000 tr/min for 1 minute 30 seconds with an emulsification device, Silverson L4RT.

### Example 2

### Stability Tests

Tests of simple stability of the type “bottle tests” have been carried out at a temperature of 60° C. so as to follow the kinetics of emulsion breaking. We consider that the breaking is complete when the two phases (organic and aqueous) are completely separated by a thin interface. The presence of a residual layer of emulsion at the end of the breaking process (thick interface) is considered to be unacceptable.

### Example 3

### Compatibility Tests

The compatibility between the filtrate of the mud, the tank fluids and the processing fluid is of major importance. Indeed, the formation of a stable emulsion among all the fluids can be the cause of additional damage or even bring about clogging of the well and must be considered as a criterion which allows for the disqualification of a cleaning formulation.

A simple test of discrimination under the conditions of weak agitation is carried out on different formulations. The experimental procedure is the following:
agitation by hand for 1 minute of a mixture composed of ⅓ of breaker (in aqueous phase, in organic phase or in emulsion), ⅓ of tank fluid (80% volume crude, 20% volume brine), and ⅓ of reconstituted oil mud filtrate (OBM). The stability of each mixture is observed as a function of time at a temperature of 60° C.

### Example 4

### Tests of Effectiveness of the Solid-Dissolving Agents

Some trials of effectiveness have been carried out with the carbonate- and barytine-dissolving agent Bw2 to evaluate its effectiveness on different mixtures of solids, wetted or not by the continuous phase of the oil mud (OBM).

In the experimental procedure for the dry solids, about 10 g of different mixtures of barytine and of carbonates (relative weights 25/75, 50/50, and 75/25) are weighed, put in a vial with 100 ml of Bw2, and agitated in a roller kiln for 20 hours at 45° C. The vial is then removed from the oven, set aside to cool and the liquid is filtered in a HPHT (high pressure high temperature) cell on a pre-weighed paper filter. Water is added to the vial and filtered until dry. Finally the paper filter and the remaining solids are placed in an oven at 60° C., removed once they are dry, and weighed.

In the experimental procedure with the solids wetted by the oil, about 10 g of barytine and carbonates are mixed with 6 ml of reconstituted oil mud filtrate (OBM) in a vial or an aging cell.

In certain trials, these wetted solids have first of all been treated by prewashing with breaker Bo1 (breaker of organo-soluble cake): 100 ml of a 1 to 2% solution of Bo1 in the HDF2000 mineral oil are added to a vial which is agitated in a roller kiln for two hours at 60° C.; the vial is then removed from the oven, set aside to cool and the liquid is filtered into a HPHT cell on a pre-weighed paper filter. The filtered solids are then put in a vial with an excess of mineral oil of low toxicity, agitated, rinsed and filtered onto a pre-weighed paper filter until reaching the dry state. The paper filter is then removed and the cake of solids is carefully transferred to another vial. The paper filter with the residual solids is transferred to a stove at 60° C., removed from the stove once dry, and weighed. 100 ml of Bw2 are added to the vial containing the wetted solids. The vial is then agitated in a roller kiln for 20 hours at 60° C., removed from the oven, set aside to cool and its contents are filtered in a HPHT cell on a second pre-weighed paper filter. Water is added to the vial to recuperate the remaining solids and the liquid obtained is filtered until the dry state. Finally, the paper filter with the solids is put in the oven at 60° C., removed once dry and dried.

The results are expressed in terms of effectiveness of dissolution: (weight of solids dissolved/initial weight of the solids)*100.

### Example 5

### Dynamic Tests of Effectiveness on Core Sample

For all the experiments carried out on porous media, core samples of Clashach sand, 70 mm long and 33 mm in diameter are used.

The sand is composed of 94.7% quartz, 2.6% potassic feldspar and a weak fraction of clay (0.7% of illite and 0.5% of chlorite). The average permeability to the brine is 500 mD and the porosity is approximately 15%.

The core samples are placed in a Hassler cell, saturated with brine (40 g/L NaCl, 5 g/L KCl) and brought to saturation of residual water (S_{wi}) by spending one night under a low flow of kerosene (η=1.45 mPa·s at 25° C.) in the direction opposite to that of the filtration. The permeability to the kerosene is measured at different flows and taken as initial permeability before damage (Ko_{Swi}).

A dynamic filtration device is then used for the injection of the oil-based mud at 60° C. under a differential pressure ΔP=35 bar. The device is equipped with a cone/plane geometry which provides a uniform proportion of shearing across the filtration surface. The mud injection procedure includes three steps:
3 hours of dynamic filtration
2 hours of static filtration
1 hour of dynamic filtration.

After putting the mud in place, the effectiveness of the processing fluid according to the invention on the cake formed in oil mud is tested with the same dynamic filtration device.

The processing fluid is filtered under differential pressure ΔP=10 bar until a volume equivalent to 10 times the porous volume. Next, the filtration of the fluid is stopped for the purpose of allowing the treatment action for a time of contact of 3 days under a differential pressure ΔP of about 0.7 bar.

The last step consists of removing the core sample and proceeding to the injection of brine (40 g/L NaCl, 5 g/L KCl) into the Hassler cell in the same direction as the filtration for one night at low flow. The permeability of the final water (K_{wf}) is measured the next day. The permeability to the initial water Kw is obtained according to the same experimental method, but without the treatment step with the cleaning fluid.

The proportion of damage in injectivity retained is defined as:

DR=100×(1−K_{wf}/K_{w}).

### Example 6

### Results

### Effectiveness of the Solid-Dissolving Agents

A commercial organic agent (acetic acid) is used to dissolve the particles of calcium carbonate (Bw1). Since the particles of barium sulfate are not attacked by the weak acids, a commercial formulation (Bw2 HDC Mark II) has been used and tested for different types of solids: barytine, calcium carbonate, and mixtures of the two. The tests are carried out at 60° C. on solids wetted by a reconstituted filtrate of oil mud. The effectiveness of the Bw2 agent is also tested with and without pretreatment of the solids wetted by the filtrate with the organo-soluble emulsion-breaking additive Bo1 (prewashing with a solution of Bo1). Complementary tests are carried out directly on the dry solids at 45° C. according to the procedures described previously.

In every case, the Bw2 formulation is effective both against the carbonates and against the barytine particles (results Table 1). The measures of effectiveness against the pure barytine and the pure carbonates are about 30% and 55% respectively and appear not to be affected by the presence of the organic acid Bw1 in the treatment solution, or by the prewashing of the solids by the organo-soluble emulsion-breaking additive Bo1. The effectiveness even seems slightly better in the case of the mixture of wetted solids (58%). The tests on dry solids at 45° C. show an increase of the effectiveness with the quantity of barytine in the mixture of solids (from 43% to 58%).

### Selection of the Water-in-Oil Emulsion Having Controlled Breaking Kinetics

Three types of emulsions are formulated with different solid-dissolving agents
(a) with Bw1 and Bw2, (b) with Bw2 but without Bw1, and (c) with Bw1 but without Bw2. Their separation kinetics at 60° C. are studied, and the quality of the residual emulsion layer at the interface between the two separated phases is systematically reported. The following parameters vary: concentration of the acid Bw1, of the emulsifier Em1 and of the hydrosoluble emulsion-breaking additive EB1.

The results are given in tables 2, 3, and 4 for the emulsions A, B, and C, which are water-in-oil emulsions at 50%/50% in volume, of density 1.2. The percentages indicated in the tables are in weights.

For table 2 (emulsions of type A): The brine is composed of 50% by volume of a saturated solution of potassium formate and 50% by volume of a saturated solution of cesium formate. The brine/Bw2 relationship is 50%/50% by volume.

For table 3 (emulsions of type B): the brine is composed of 50% by volume of a saturated solution of potassium formate and 50% by volume of a saturated solution of cesium formate. The brine/Bw2 relationship is 50%/50% by volume.

For table 4 (emulsions of type C): the brine is composed of a saturated solution of potassium formate.
1. Emulsions A with Bw1 and B2 (Table 2): in absence of the hydrosoluble additive EB1, the emulsions are very stable. The reduction of the concentration of acid at 0.1 M makes possible a slow separation, but with a residual emulsion layer at the interface. The addition of EB1 (surfactant in aqueous phase) seems necessary in order to control the kinetics of complete separation of the two phases. An emulsion formed from 0.3 M acid, 0.5% EB1, and 0.5% Em1 begins to break at the end of 5 hours.
2. Emulsion B with Bw2 and without Bw1 (Table 3): The emulsions are not stable. A residual emulsion layer is observed in the absence of the EB1 additive.
3. Emulsions C with Bw1 and without Bw2 (Table 4): the emulsions obtained are very stable. The addition of the additive EB1 allows for a complete separation of the phases without any residual emulsion layer at the interface. The time required for the complete separation is longer as the EB1 is weaker. Emulsions containing at least 0.5% of emulsifier are stable for several hours.

The EB1 additive is thus essential in the control of the separation kinetics. In laboratory conditions, the emulsions according to the invention A6 and C4 are stable for a duration comprised between 8 and 17 hours. The principal rheological parameters determined in the Fann 35 at 25° C. (AV: apparent viscosity, PV: plastic viscosity, YV: threshold tension) are given in Table 5.

The two emulsions A6 and C4 can be used to destabilize the cakes formed by the oil muds weighted with carbonates, provided that emulsion A6 is more particularly adapted to the treatment of the cakes formed from muds containing barytine.

TABLE 1

| | 60° C. - Wetted solids | | | 45° C. - Dry solids | | |
|---|---|---|---|---|---|---|
| | | | 25% | 25% | 50% | 75% |
| | | | Barytine | Barytine | Barytine | Barytine |
| | 100% | 100% | 75% | 75% | 50% | 25% |
| | Barytine | Carbonate | Carbonate | Carbonate | Carbonate | Carbonate |
| 0% Bo1 | 35 | 53 | 58 | 43 | 55 | 58 |
| 0% Bo1 + | 27 | 55 | — | — | — | — |
| Bw1 1M* | | | | | | |
| 1% Bo1 | 35 | 55 | — | — | — | — |
| (prewashing) | | | | | | |
| 2% Bo1 | 32 | 53 | — | — | — | — |
| (prewashing) | | | | | | |

*Bw1 1M added in the aqueous phase with Bw2

TABLE 2

| | A1 | A2 | A3 | A4 | A5 | A6 |
|---|---|---|---|---|---|---|
| Brine + Bw2 | x | x | x | x | x | x |
| (aqueous phase) | | | | | | |
| Bw1 (aqueous | 1M | 1M | 0.1M | 0.1M | 0.3M | 0.3M |
| phase) | | | | | | |
| EB1 (aqueous | 0% | 1% | 0% | 1% | 0.5% | 0.5% |
| phase) | | | | | | |
| HDF2000 + 1% | x | x | x | x | x | x |
| Bo1 (oil phase) | | | | | | |
| Em1 (oil phase) | 0.3% | 0.3% | 0.3% | 0.3% | 0.3% | 0.5% |
| Separation time | stable | >6 hours | >6 hours | 1 hr. 30 min. | 4 hours | >6 hours |
| Residual emulsion | — | 0 | 1 cm | 0 | 0 | 0 |
| layer | | | | | | |

TABLE 3

| | B1 | B2 | B3 | B5 | B6 | B7 | B8 |
|---|---|---|---|---|---|---|---|
| Brine + Bw2 | x | x | x | x | x | x | x |
| (aqueous phase) | | | | | | | |
| EB1 (aqueous | 0% | 1% | 0.1% | 0% | 0% | 0% | 1% |
| phase) | | | | | | | |
| HDF2000 + 1% | x | x | x | x | x | x | x |
| Bo1 (oil phase) | | | | | | | |
| Em1 (oil phase) | 0.3% | 0.3% | 0.3% | 0.5% | 0.7% | 1% | 1% |
| Separation time | 1 hr. 45 min. | 8 min. | 1 hour | 2 hrs. 45 min. | >3 hours | >3 hrs. | 55 min. |
| | | | | | | 10 min. | |
| Residual | 0.5 cm | 0 | 0.2 cm | 1 cm | 2 cm | 2 cm | 0 |
| emulsion layer | | | | | | | |

TABLE 4

| | C1 | C2 | C3 | C4 | C5 |
|---|---|---|---|---|---|
| Brine (Aqueous | x | x | x | x | x |
| phase) | | | | | |
| Brine + Bw2 | 1M | 1M | 1M | 1M | 1M |
| (aqueous phase) | | | | | |
| EB1 (aqueous phase) | 0% | 1% | 0.5% | 0.5% | 0.3% |
| HDF2000 + 1% Bo1 | x | x | x | x | x |
| (oil phase) | | | | | |
| Em1 (oil phase) | 0.3% | 0.3% | 0.5% | 0.7% | 0.7% |
| Separation time | several | several | several | several | several |
| | hours | hours | hours | hours | hours |
| Residual emulsion | 2 cm | 0 | 0 | 0 | 0 |
| layer | | | | | |

TABLE 5

| | AV (mPa · s) | PV (mPa · s) | YV (lb/100 ft2) |
|---|---|---|---|
| Emulsion A6 | 50 | 44 | 12 |
| Emulsion C4 | 47 | 35 | 25 |

Tests of Compatibility with the Tank Fluids

The compatibility of the formulations with the tank fluids is evaluated by tests of compatibility between the mud filtrate, the tank fluids, and the processing fluid. A stable emulsion among these constituents must not be formed, at the risk of generating additional damage or even a clogging of the well.

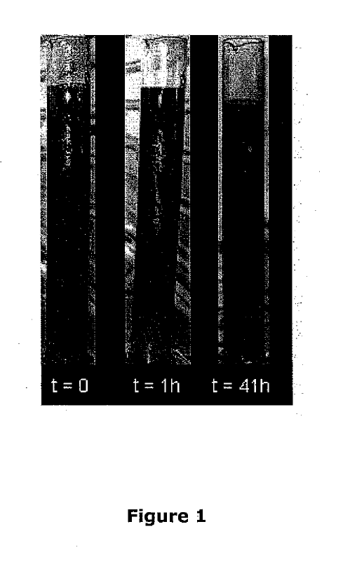

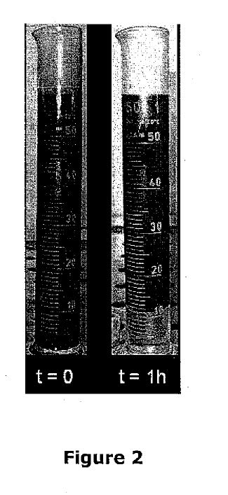

All the tests show a major effect of the hydrosoluble additive EB1 on the performance with regard to compatibility. FIG. 1 shows the evolution of an emulsified system formed by the manual mixing between the tank fluids and an emulsion containing no EB1: the separation between the organic phase and the aqueous phase is incomplete, even after several hours, and the aqueous phase remains very dark, composed of a concentrated water-in-oil emulsion. On the contrary, the same system tested with an emulsion containing the additive EB1 shows a very good separation after one hour, and the separated aqueous phase is clear and not emulsified. (FIG. 2).

### Reduction of the Proportion of Damage

The effectiveness of the fluid A6 is tested against the cake formed by OBM2 (carbonate and barytine) and that of the fluid C4 against the cake formed by OBM1 (carbonate alone).

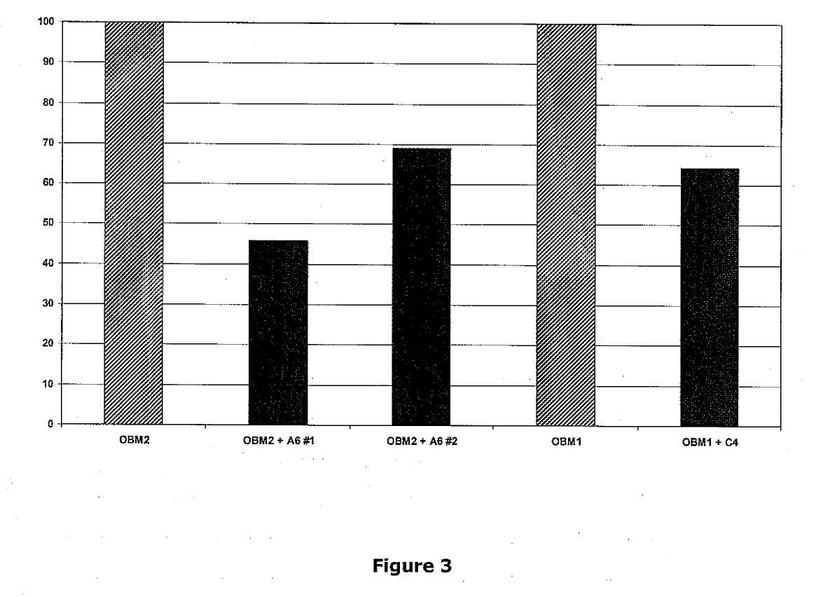

FIG. 3 shows the results obtained in terms of the proportion of standardized damage in retained injectivity. The proportion of damage in injectivity retained being DR=100×(1−K_{wf}/K_{w}), the proportion of standardized damage is (DR (with treatment)/DR (blank, without treatment))×100.

The results show a reduction of the proportion of damage in all the cases: reduction of between 30 and 50% for the emulsion A6 and reduction of about 40% for the emulsion C4.

1. Processing fluid for the cleaning of wells drilled with oil muds by elimination of filtration cake, in the form of a water-in-oil emulsion comprising:
a. a continuous organic phase comprising at least one organo-soluble emulsion-breaking additive;
b. a dispersed aqueous phase comprising at least one solid-dissolving agent and at least one hydrosoluble additive allowing for the controlled breaking down of the processing fluid;
c. at least one emulsifying agent;
d. at least one weight-increasing agent in the form of soluble salts, the proportion and the nature of the hydrosoluble additive being chosen so as to obtain a delayed effect for the breaking down.

2. Fluid according to claim 1 comprising from 20 to 80% by volume of continuous organic phase.

3. Processing fluid according to claim 1 in which the emulsifier is a non-ionic surfactant.

4. Processing fluid according to claim 1 comprising from 0.05% to 3% by weight of emulsifier with respect to the continuous organic phase.

5. Processing fluid according to claim 4 comprising from 0.1 to 1% by weight of emulsifier with respect to the continuous organic phase.

6. Processing fluid according to claim 5 comprising from 0.2 to 0.8% by weight of emulsifier with respect to the continuous organic phase.

7. Processing fluid according to claim 1 in which the organo-soluble emulsion breaker is an organic formulation comprising at least one constituent chosen from among the non-ionic or cationic surfactants of the type: copolymers of ethylene oxide and propylene oxide, the derivatives of alcohols or of phenols with alkoxylated or polyalkoxylated chains, polyalkylene glycols, polyamines, alkoxylated derivatives or polyalkoxylated amines, quaternary ammonium salts, quaternized alkanolamine esters, and the siliconized derivatives, the non-ionic amphiphilic compositions obtained by the reaction of at least one polymerized vegetable oil, on at least one aminoalcohol, and the alkylic esters of fatty acids derived from natural, vegetable, or animal oils, possibly alkoxylated or polyalkoxylated, as well as any other derivative of fatty acids, in particular the polymerized unsaturated monocarboxylic fatty acids;

8. Processing fluid according to claim 1 in which the solid-dissolving agent is chosen from among the weak or strong acids, the mixtures of strong acids and chelating agents, and the specific barytine-dissolving agents, alone or in a mixture.

9. Processing fluid according to claim 1 in which the hydrosoluble additive is a weakly hydrosoluble ester of fatty acid.

10. Processing fluid according to claim 1 in which the weight-increasing agent is chosen from among the anionic salts of the chloride, bromide and formate type, the cation being chosen from among calcium, sodium, potassium, and cesium.

11. Processing fluid according to claim 10 in which the weight-increasing agent is potassium formate or cesium formate.

12. Method of treatment of the wells bored with oil-based muds comprising a single cleaning step c) comprising:
a) preparing a processing fluid in the form of a water-in-oil emulsion comprising:
i. a continuous organic phase comprising at least one organo-soluble emulsion-breaking additive;
ii. a dispersed aqueous phase comprising at least one solid-dissolving agent and at least one hydrosoluble additive allowing for a delayed effect of the breakdown of the processing fluid;
iii. at least one emulsifying agent;
iv. at least one weight-increasing agent in the form of soluble salts.
b) injecting said emulsion in the well by controlling the kinetics of breakdown of the processing fluid by means of the hydrosoluble additive so as to ensure the breaking of the water-in-oil emulsion in place;
c) eliminating the filtration cake by breaking down of the filtration cake at the wall by means of the organo-soluble additive and by dissolving the solids of the cake by means of the solid-dissolving agent.

13. Method of treatment of wells according to claim 12 in which we verify the compatibility of the processing fluid with the tank fluids.

14. Method of treatment of wells according to claim 12 in which the well is an injection well.

15. Method of treatment of wells according to claim 14 in which the well is a water injection well.

16. Method of treatment of wells according to claim 12 in which the organo-soluble additive is an organic formulation comprising at least one constituent chosen from among the non-ionic or cationic surfactants of the type copolymers of ethylene oxide and propylene oxide, the derivatives of alcohols or of phenols with alkoxylated or polyalkoxylated chains, polyalkylene glycols, polyamines, alkoxylated derivatives or polyalkoxylated amines, quaternary ammonium salts, quaternized alkanolamine esters, and the siliconized derivatives, the non-ionic amphiphilic compositions obtained by the reaction of at least one polymerized vegetable oil, on at least one amino alcohol, and the alkylic esters of fatty acids derived from natural, vegetable, or animal oils, as well as any other derivative of fatty acids, in particular the polymerized unsaturated monocarboxylic fatty acids.

17. Method of treatment of wells according to claim 12 in which the solid-dissolving agent is chosen from among the weak or strong acids, the mixtures of strong acids and chelating agents, and the specific barytine-dissolving agents, alone or in a mixture.

18. Method of treatment of the injection wells according to claim 12 in which the hydrosoluble additive allowing for delayed effect is a weakly hydrolysable ester of fatty acid.
